(19) United States
(12) Patent Application Publication
(10) Pub. No.: US 2007/0157729 A1
(43) Pub. Date: Jul. 12, 2007

(54) Non-explosive shockwave generator system and method for hydrodynamic pressure processing of food products

(76) Inventors: John Williams, Maynard, MA (US); Peter A. Warren, Newton, MA (US); James Carter, Bedford, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/329,947

(22) Filed: Jan. 10, 2006

(51) Int. Cl. G01N 29/04

(52) U.S. Cl. 73/584

(57) ABSTRACT

A non-explosive shockwave generator system for hydrodynamic pressure processing of food products, the generator including a volume of fluid about a food product, a piston in a cylinder arranged to strike the volume, and a subsystem for driving the piston to impact the volume of fluid to create a shockwave which travels through the food product.

### GOVERNMENT RIGHTS

This invention was made with U.S. Government support under Contract No. 2002-33610-11851 by the U.S. Department of Agriculture.

### FIELD OF THE INVENTION

This invention relates to a non-explosive shockwave generator system for hydrodynamic pressure processing of food products.

### BACKGROUND OF THE INVENTION

High-pressure shockwaves are often utilized as a means of killing microbial organisms, e.g., bacteria, and improving tenderness in food products such as boneless cuts of beef, chicken, pork, and the like. Conventional hydrodynamic pressure processing (HDP) systems and methods rely on detonating an explosive charge in a vessel filled with fluid (e.g., water) and a vacuum-packed food product. The detonated explosive charge generates a powerful shockwave that travels through the fluid and into the muscle tissue of the meat. If done properly, the shockwave disrupts the myofibrillar structure of the muscle tissue and tenderizes the meat. The shockwave can also rupture the cell walls of certain strains of bacteria, e.g., E. coli, in the food product to effectively destroy the bacteria. Thus, the goal of HDP systems and methods is a more tender, consistent cut of meat with improved food safety and shelf life.

However, detonating explosives charges in a fluid presents safety concerns and introduces chemicals (by-products of the explosion) into the fluid that can contaminate the food product. The explosive charge utilized by conventional HDP systems also generates a spherical shockwave that has minimal interaction with the food product. This limits the amount of tenderization achieved and the ability to kill bacteria. Moreover, conventional HDP systems that rely on detonating explosive charges in the fluid can only be batch processed which prevents continuous processing and mass production.

### SUMMARY OF THE INVENTION

It is therefore an object of this invention to provide a non-explosive shockwave generator system and method for hydrodynamic pressure processing of food products.

It is a further object of this invention to provide such a shockwave generator system and method that eliminates the need to detonate an explosive charge.

It is a further object of this invention to provide such a shockwave generator system and method which eliminates unwanted chemical by-products in the fluid associated with detonating an explosive charge in the fluid.

It is a further object of this invention to provide such a shockwave generator system and method which is safer.

It is a further object of this invention to provide such a shockwave generator system and method which efficiently tenderizes a food product.

It is a further object of this invention to provide such a shockwave generator system and method which efficiently destroys microbial organisms in a food product.

It is a further object of this invention to provide such a shockwave generator system and method which provides for continuous processing.

It is a further object of this invention to provide such a shockwave generator system and method which improves the interaction between the shockwave and the food product.

It is a further object of this invention to provide such a shockwave generator in which the shockwave can be defined and controlled.

The subject invention results from the realization that an innovative non-explosive shockwave generator for hydrodynamic processing of food products can be achieved, not by detonating dangerous explosive charges in a volume of fluid that introduce dangerous chemicals into the fluid and cannot be continuously processed, but instead by utilizing a piston that strikes a volume of fluid about the food product to create shockwave which travels through the food product and efficiently tenderizes the food product and destroys certain microbial organisms therein.

The subject invention, however, in other embodiments, need not achieve all these objectives and the claims hereof should not be limited to structures or methods capable of achieving these objectives.

This invention features a non-explosive shockwave generator system for hydrodynamic pressure processing of food products, the generator including a volume of fluid about a food product, a piston in a cylinder arranged to strike the volume, and a subsystem for driving the piston to impact the volume of fluid to create a shockwave which travels through the food product.

In one embodiment, the volume of fluid may include a portion within the cylinder. The cylinder may include a volume of gas proximate the volume of fluid. The cylinder may include vents for allowing the volume of gas to escape from the cylinder when the piston is driven to impact the volume of fluid. The piston may impact the volume of fluid to generate a planar shockwave. The food product may be chosen from the group consisting of beef, poultry, pork and lamb. The subsystem may drive the piston at a velocity in the range of about 50 to 150 m/s. The piston may generate an incident shock pressure on the volume of fluid that has a pressure in the range of about 700 bar to 2000 bar. The piston may generate an incident shock pressure having a pressure of about 1500 bar. The piston may have a mass in the range of about 2 pounds to about 12 pounds. The driving subsystem may include a source of a pressurized gas delivered to the cylinder to drive the piston to impact the fluid. The driving subsystem may include an electric linear motor. The driving subsystem may include a combustion generating device. The driving subsystem may include springs in communication with the piston. The driving subsystem may include a hydraulic device. The piston may be concave shaped for generating a complex shockwave. The piston may be convex shaped for generating a complex wave form. The piston may include an angled head for generating a complex shockwave. The volume of fluid may include a linear pocket feeder which continuously presents the food product to be processed. The linear pocket feeder may include a conduit in fluid communication with the cylinder and a plurality of pistons connected by rods travelling in the conduit. The conduit may include fluid lines for filling a volume of fluid between two adjacent pistons of the plurality of pistons to form a plurality of filling stations to provide the volume of fluid about the food product. The conduit may include fluid lines for draining the volume of fluid about the food product and between adjacent pistons to form a plurality of draining stations.

This invention also features a non-explosive shockwave generator system for hydrodynamic pressure processing of food products, the generator including a volume of fluid about a food product, a piston in a cylinder arranged to strike the volume, and a subsystem for driving the piston to impact the volume of fluid to create a planar shockwave which travels through the food product.

This invention also features a non-explosive shockwave generator system for hydrodynamic pressure processing of food products, the generator including a volume of fluid about a food product, a striking element arranged to strike the volume, and a subsystem for driving the striking element to impact the volume of fluid to create a shockwave which travels through the food product.

This invention further features a non-explosive shockwave generator system for hydrodynamic pressure processing of food products, the generator including a volume of fluid about a food product, a piston in a cylinder arranged to strike the volume, a subsystem for driving the piston to impact the volume of fluid to create a shockwave which travels through the food product, and a linear pocket feeder which continuously presents the food product to be processed.

In one embodiment, the pocket feeder may include a conduit in fluid communication with the cylinder and a plurality of pistons connected by rods travelling in the conduit. The conduit may include fluid lines for filling a volume of fluid between two adjacent pistons of the plurality of pistons to form a plurality of filling stations to provide the volume of fluid about the food product. The conduit may include fluid lines for draining the volume of fluid about the food product and between adjacent pistons to form a plurality of draining stations.

This invention also features a non-explosive method for generating a shockwave for hydrodynamic processing of food products, the method including delivering a food product to a volume of fluid, and driving a piston in a cylinder arranged to strike the volume to impact the volume of fluid to create a shockwave which travels through the food product.

In one embodiment, the volume of fluid may include a portion within the cylinder. The cylinder may include a volume of gas proximate the volume of fluid. The food product may be chosen from the group consisting of beef, poultry, pork and lamb. A subsystem may drive the piston to impact the volume of fluid and create the shockwave. The driving subsystem may include a source of a pressurized gas delivered to the cylinder to drive the piston to impact the fluid. The driving subsystem may include an electric linear motor, a combustion generating device, springs in communication with the piston, and a hydraulic device.

This invention also features a non-explosive method for generating a shockwave for hydrodynamic processing of food products, the method including delivering a food product to a volume of fluid, and impacting the volume of fluid to create a shockwave which travels through the food product.

In one embodiment, the impacting includes driving a piston in a cylinder arranged to strike the volume of fluid. The volume of fluid may include a portion within the cylinder. The cylinder may include a volume of gas proximate the volume of fluid. The food product may be chosen from the group consisting of beef, poultry, pork and lamb. The pressurized gas may drive the piston to impact the fluid. The electric linear motor may drive the piston. The combustion may be used to drive the piston. The at least one spring may drive the piston. The piston may be driven hydraulically.

This invention also features a non-explosive method for generating a shockwave for hydrodynamic processing of food products, the method including delivering a food product to a volume of fluid, and applying a non-explosive force to the volume of fluid to create a shockwave that travels through the food product.

This invention also features a non-explosive method for generating a shockwave for hydrodynamic processing of food products, the method including delivering a food product to a volume of fluid, and tenderizing and destroying microbial organisms in the food product by applying a non-explosive force to the volume of fluid to create a shockwave that travels through the food product.

This invention also features a non-explosive method for generating a shockwave for hydrodynamic processing of food products, the method including sequentially delivering a food product to a volume of fluid using a linear pocket feeder, and driving a piston in a cylinder arranged to strike to volume to impact the volume of fluid to create a shockwave which travels through the food product.

In one embodiment, the pocket feeder may include a conduit in fluid communication with the cylinder and a plurality of pistons connected by rods travelling in the conduit.

This invention further features a non-explosive method for generating a shockwave for hydrodynamic processing of food products, the method including sequentially delivering a food product to a volume of fluid using a linear pocket feeder, and applying a non-explosive force to the volume of fluid to create a shockwave that travels through the food product.

### BRIEF DESCRIPTION OF THE DRAWINGS

Other objects, features and advantages will occur to those skilled in the art from the following description of a preferred embodiment and the accompanying drawings, in which:

FIG. 1 is a schematic three-dimensional view of one embodiment of the non-explosive shockwave generator system for hydrodynamic pressure processing of a food product of this invention;

FIGS. 2A-2B are schematic side-views showing an example of the piston shown in FIG. 1 striking a volume of fluid to create a shockwave in the fluid that interacts with the food product;

FIG. 3 is a schematic side-view of one example of the subsystem for driving the piston shown in FIG. 1;

FIG. 4 is a schematic side-view of another example of the subsystem used to drive the piston shown in FIG. 1;

FIG. 5 is a schematic side-view of yet another example of the subsystem for driving the piston shown in FIG. 1;

FIG. 6 is a three-dimensional view of another embodiment of the non-explosive shockwave generator system for hydrodynamic pressure processing of a food product of this invention;

FIG. 7 is a schematic three-dimensional view of the non-explosive shockwave generator system for hydrodynamic pressure processing of a food product shown in FIG. 1 employed with a linear pocket feeder;

FIGS. 8A-8C are schematic side-views showing an example of a concave shaped piston that may be employed with the shockwave generator system and method of this invention to strike a volume of fluid and create a complex shockwave;

FIGS. 9A-9C are schematic side-views showing an example of a convex shaped piston that may be employed with the shockwave generator system and method of this invention to strike that is used to impact a volume of fluid and create a complex shaped wave form; and

FIGS. 10A-10C are schematic side-views showing an example of a sloped shaped piston that may be employed with the shockwave generator system and method of this invention to strike a volume of fluid and create a complex shockwave.

### PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

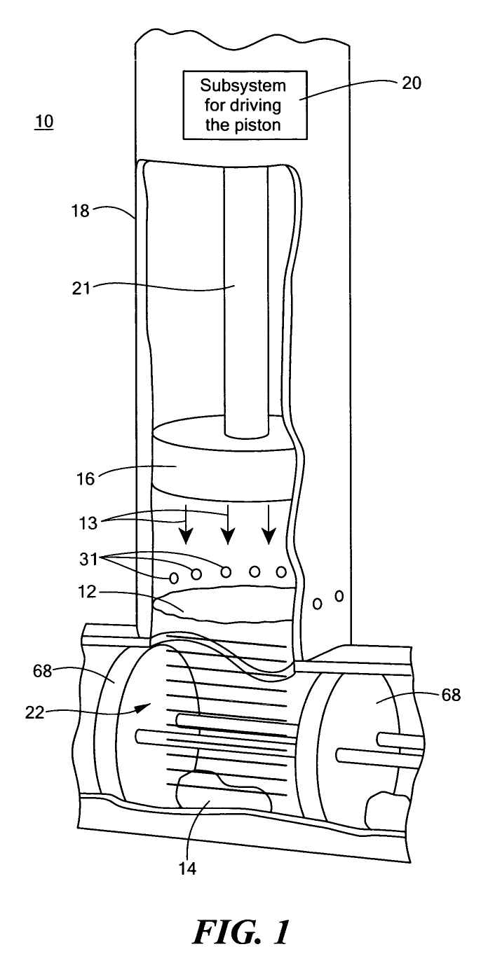

There is shown in FIG. 1 an example of a non-explosive shockwave generator system in accordance with this invention. System 10 includes volume of fluid 12 about food product 14. Volume of fluid 12 is typically water, although any type of fluid known to those skilled in the art may be utilized. Food product 14 is typically a meat product, such as a boneless cut of beef, pork, chicken, or similar food product. Piston 16 is disposed in cylinder 18 and is arranged to strike the volume of fluid 12 in the direction shown by arrows 13. Subsystem 20 (discussed below) drives piston 16, typically with shaft 21 (although pressurized gas may also be used, as discussed below) to impact or strike volume of fluid 12 and create shockwave 22 which travels through volume of fluid 12 and through food product 14. Vents 31 allow the gas (e.g., air) in cylinder 18 to escape when piston 16 is driven to strike volume of fluid 12. Shockwave 22 interacts with food product 14 by disrupting the myofibrils therein to increase the tenderness of the food product 14 (e.g., a cut of beef, chicken, pork, lamb and the like). Shockwave 22 can also destroy various microbial organisms that may be present in food product 14 by rupturing the cell walls of the microbial organisms, e.g., gram-negative bacteria, such as E. coli. Because hydrodynamic generator system 10 of this invention eliminates the need to detonate explosive charges in volume of fluid 12, system 10 is safer than conventional HDP systems and the problems associated with the by-products of the explosive charges contaminating volume of fluid 12 and food product 14 are eliminated.

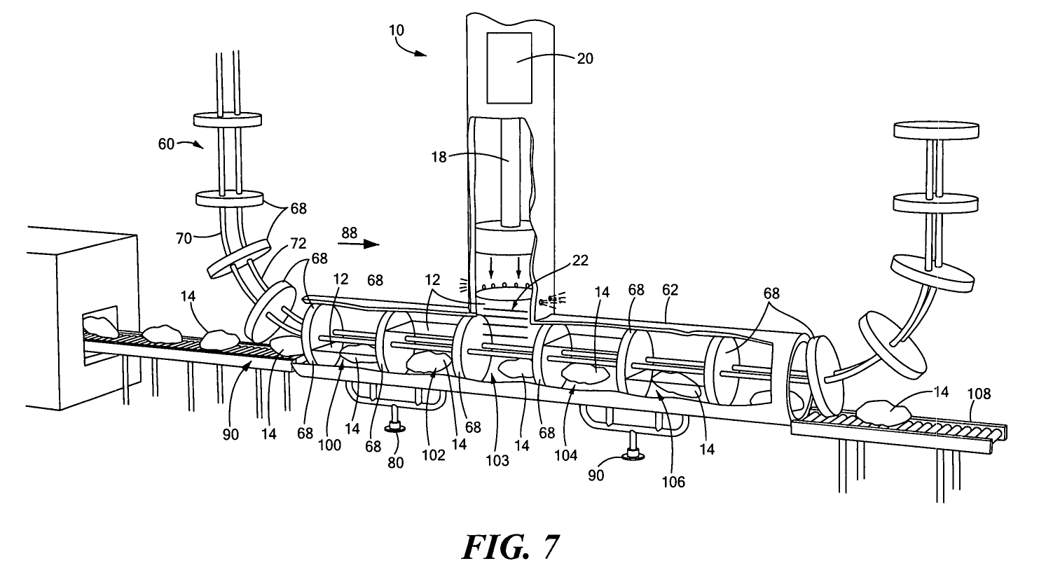

For continuous processing, volume of fluid 12 is defined by spaced pistons 68, FIG. 7, of linear pocket feeder 60 in conduit 62. Food product 14 is disposed between the spaced pistons 68 as shown and continuously presented to piston 16 in cylinder 18 as described in detail below. Such a continuous process cannot be employed in a conventional HDP system.

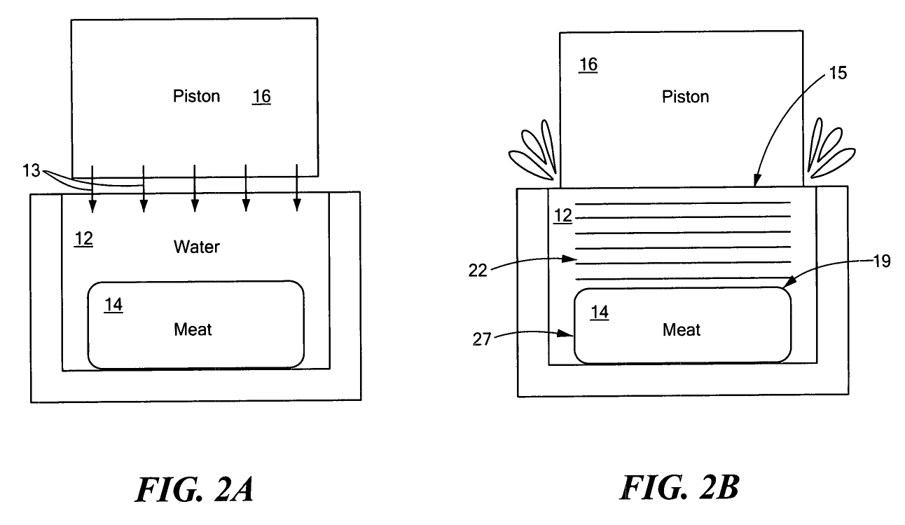

As shown in greater detail in FIG. 2A, where like parts have been given like numbers, piston 16 is driven to strike or impact volume of fluid 12, as indicated by arrows 13. When piston 16, FIG. 2B, impacts volume of fluid 12 about food product 14, indicated by arrow 15, shockwave 22 is generated in volume of fluid 12 and travels through food product 14, as indicated by arrow 27 to tenderize and kill microbial organisms therein. In one preferred embodiment, shockwave 22 may be planar as shown in FIGS. 1 and 2B. Because shockwave 22 is planar (flat), as opposed to a spherical shockwave typically generated by conventional HDP systems, substantially all of shockwave 22 strikes food product 14, as indicated by arrow 19 and travels through food product 14. Hence, planar shockwave 22 disrupts a greater number of the myofibrils in the muscle tissue in food product 14 than the spherical shock wave of conventional HDP systems. The result is an increase in the tenderization achieved to food product 14. In one example, tenderness improvements average about 17% to as high as 25% when compared to conventional HDP systems. Moreover, planar shockwave 22 has been shown to kill microbial organisms present in food product 14. In one example, reductions in purge fluid bacterial colony forming units (CFU) were significant and consistent, ranging between 0.14 and 0.97 log CFU/mL (28-89%).

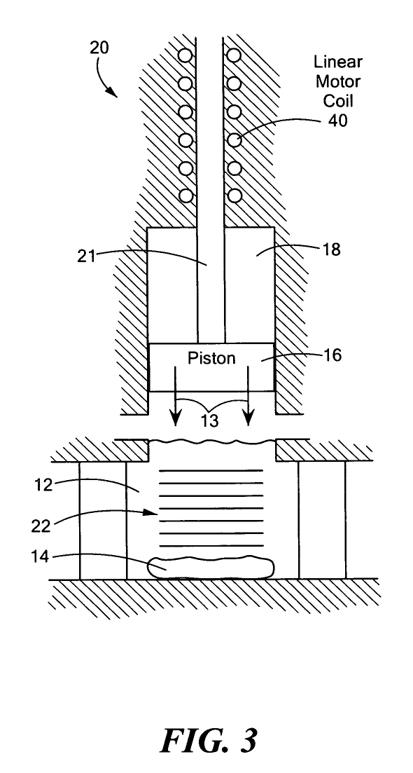

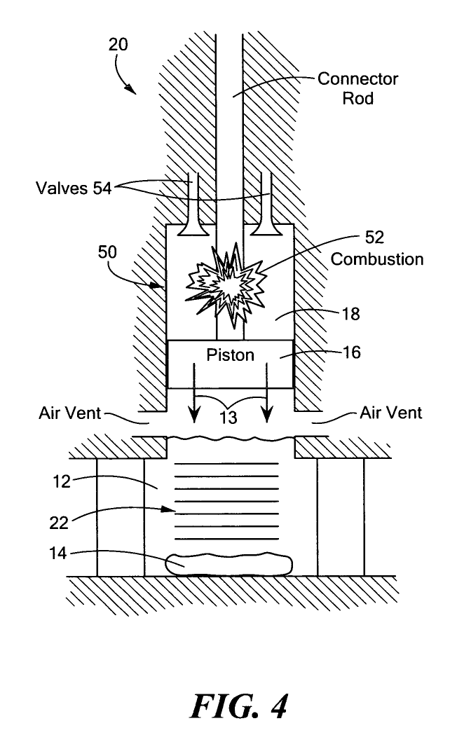

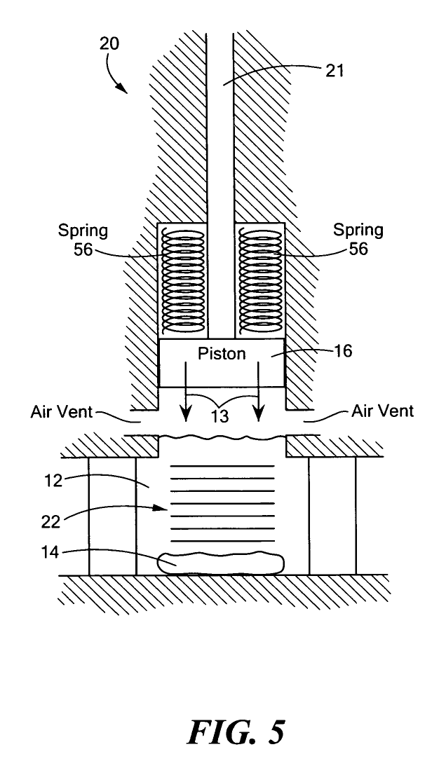

One example of subsystem 20, FIG. 1 that may be utilized to drive piston 16 to impact volume of fluid 12 includes linear motor coil 40, FIG. 3, where like parts have been given like numbers. Linear motor coil 40 is connected to shaft 21 and drives piston 16 in cylinder 18 in the direction indicated by arrows 13 to strike volume of fluid 12 and generate shockwave 22 that travels through food product 14. In other designs subsystem 20, FIG. 4, includes combustion system 50 for driving piston 16 to impact volume of fluid 12 and create shockwave 22. Combustion system 50 is similar in design to a conventional combustion engine and typically ignites a fuel/air mixture (e.g., vaporized gasoline) in sealed in cylinder 18 above piston 16 to generate combustion 52 that drives piston 16 in the direction indicated by arrows 13. Valves 54 allow for the combusted gas to escape. Although combustion system 50 utilizes combustion, the gas is sealed from volume of fluid 12 and food product 14 by piston 16 to prevent contamination of volume of fluid 12 and food product 14. In yet another example, subsystem 20, FIG. 5 may include heavy duty compressed springs 56 that drive piston 16 in the direction shown by arrows 13 to impact volume of fluid 12 and generate shockwave 22. A compression device (not shown) connected to shaft 21 is used to compress springs 56 after piston 16 has impacted volume of fluid 12. In other designs, subsystem 20 may include a hydraulic system for driving piston 16 (not shown).

Subsystem 20 as shown in FIGS. 1 and 3-5 typically drives piston 16 at a velocity of about 50 to 150 m/s with a preferred velocity of about 30 m/s. The mass of piston 16 is typically 2 to 12 pounds (0.91 kg to 5.44 kg) with a preferred mass of about 8 pounds (3.63 kg). By tailoring the mass of piston 16 and velocity that piston 16 strikes volume of fluid 12, the shock pressure and duration created when piston 16 strikes volume of fluid 12 can be controlled and a wide variety of shockwave profiles for shockwave 22 can be generated. The incident shock pressure achieved when piston 16 strikes volume of fluid 12 is about 700 bar to 2000 bar.

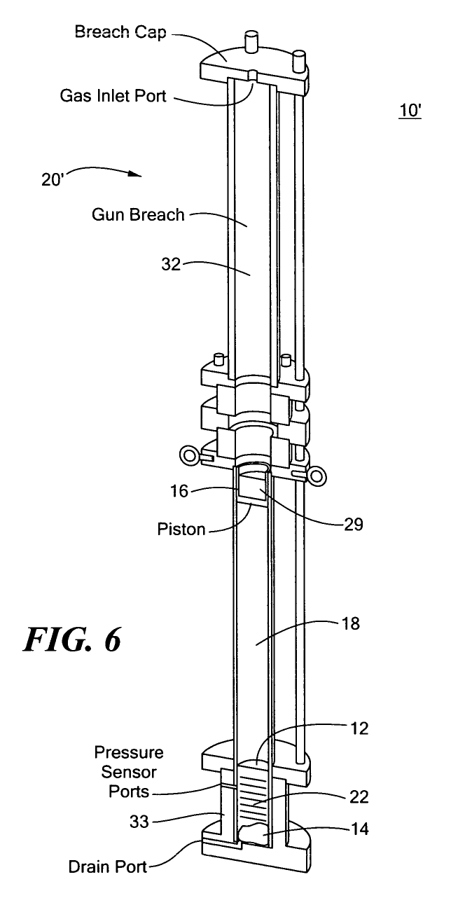

In one prototype example, non-explosive shockwave generator system 10′, FIG. 6, where like parts have been given like numbers, is configured as a high pressure airgun that utilizes subsystem 20′ to drive piston 16 to strike volume of fluid 12. In this example, subsystem 20′ utilizes high pressurized gas injected into chamber 32 (e.g., a gun breach) by inlet port 44. The high pressured gas in chamber 32 drives piston 16 (typically made of brass or similar materials with weights 29 therein) in cylinder 18 (e.g., a gun barrel) to impact volume of fluid 12 in catcher vessel 33 to create shockwave 22 that travels through food product 14. In one example, the pressurized air chamber 32 drives piston 16 at a sufficient velocity (e.g., 100 m/s) to generate an incident shock pressure on volume of fluid 12 that has a pressure of about 1500 bar.

In one preferred embodiment, non-explosive shockwave generator system 10, FIG. 7 of this invention, where like parts have been given like numbers, includes linear pocket feeder 60 which continuously presents food product 14 in volume of fluid 12 to cylinder 18 and piston 16 to be processed. Linear pocket feeder 60 typically includes conduit 62 in fluid communication with cylinder 18. Linear pocket feed 60 includes a plurality of pistons 68 connected by rods 70 and 72. As linear pocket feeder 60 moves through conduit 62 in the direction indicated by arrow 88, the plurality of pistons 68 connected by rods 70 and 72 first trap food product 14, as shown by arrow 90. As linear pocket feeder 60 travels further into conduit 62, the plurality of pistons 68 connected by rods 70 and 72 form filling stations 100 and 102 in conduit 62. Fluid, e.g., water, is injected into filling stations 100 and 102 by filling line 80 to provide volume of fluid 12 about food product 14 in each of filling stations 100 and 102. Linear pocket feeder 60 then moves in a position below piston 16 and cylinder 18, as indicated by arrow 103. Piston 16 is then driven to impact volume of fluid 12 about food product 14 to generate shockwave 22 that travels through food product 14 and to tenderize and destroy bacteria in food product 14, as discussed above. Linear pocket feeder 60 then moves plurality of pistons 68 connected by rods 70 and 72 proximate draining stations 104 and 106. The fluid is then drained via drain line 91. Linear pocket feeder 60 then advances food product 14 to conveyor belt 108 and food product 14 proceeds to the boxing operation. The result is that system 10 with linear pocket feeder 60 provides continuous processing of food product 14 to efficiently mass produce food product 14 that is tenderized and has a significant amount of the microbial organisms therein destroyed.

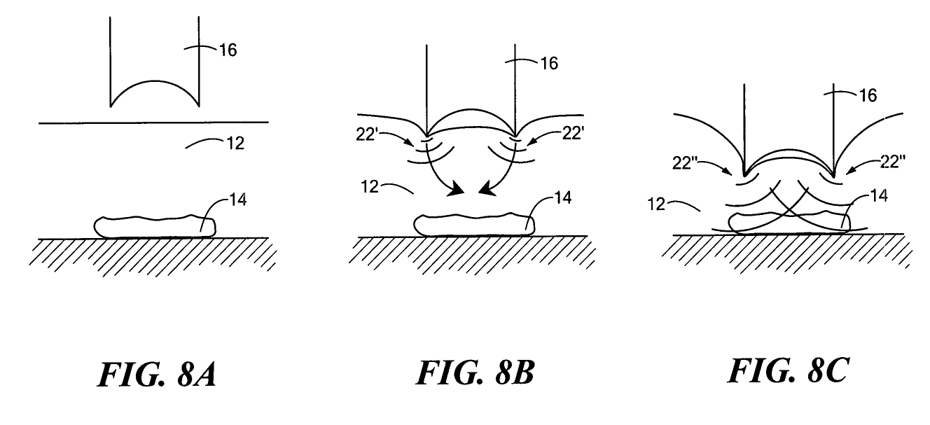

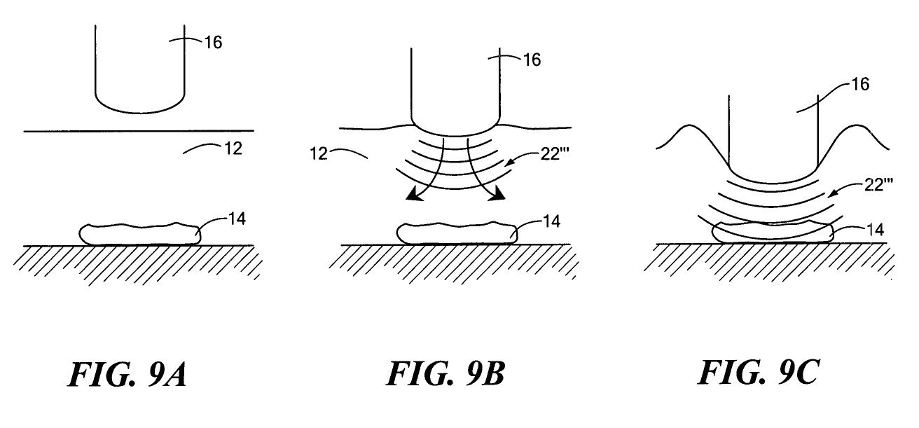

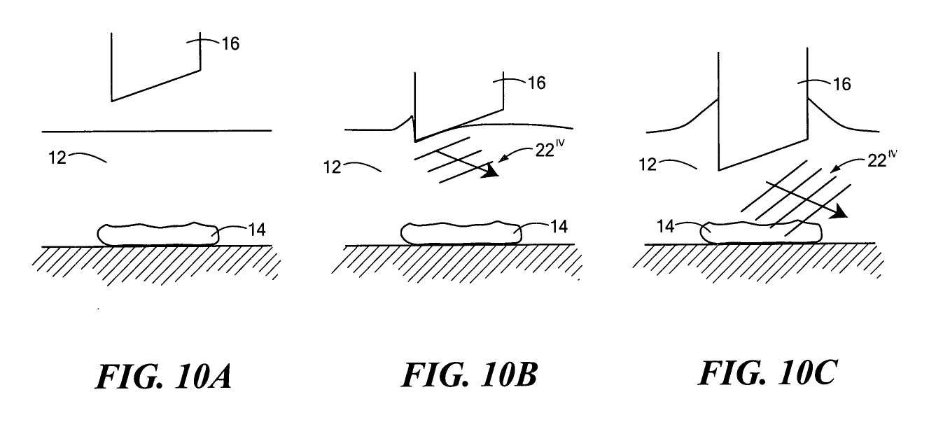

Although as shown in FIGS. 1-7, piston 16 impacts volume of fluid 12 to create a planar shockwave 22 that travels through food product 14 to tenderize and destroy bacteria in the food product 14, this is not a necessary limitation of this invention. In other embodiments, piston 16 may have a non-flat face and is used to create complex shockwaves that travel through food product 14 to tenderize and kill bacteria therein. For example, as shown in FIG. 8A, piston 16 has a concave shaped face that strikes volume of fluid 12, FIG. 8B to create parallel spherical shockwaves 22′ that form complex waveform 22″, FIG. 8C. In other examples, piston 16 may have a convex shaped face as shown in FIG. 9A that strikes volume of fluid 12, as shown in FIG. 9B, to create complex shockwave 22′″ that travels through food product 14, as shown in FIG. 9C. In yet another example, piston 16, FIG. 10A, may have a slanted face and strikes volume of fluid 12, as shown in FIG. 10B to generate complex waveform 22^{IV} that travels through food product 14, as shown in FIG. 10C.

Although as described above in reference to FIGS. 1-10C, a piston in a cylinder is used to strike or impact the volume of fluid to create the shockwave that travels through the food product, this is not a necessary limitation of this invention, as any striking element and/or subsystem and method thereof may be used to impact the volume of fluid to create a shockwave which travels through the food product.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A non-explosive shockwave generator system for hydrodynamic pressure processing of food products, the generator comprising:
a volume of fluid about a food product;
a piston in a cylinder arranged to strike the volume; and
a subsystem for driving the piston to impact the volume of fluid to create a shockwave which travels through the food product.

2. The shockwave generator system of claim 1 in which the volume of fluid includes a portion within the cylinder.

3. The shockwave generator system of claim 1 in which the cylinder includes a volume of gas proximate the volume of fluid.

4. The shockwave generator system of claim 3 in which the cylinder includes vents for allowing said volume of gas to escape from the cylinder when the piston is driven to impact the volume of fluid.

5. The shockwave generator system of claim 1 in which the piston impacts the volume of fluid to generate a planar shockwave.

6. The shockwave generator system of claim 1 in which the food product is chosen from the group consisting of beef, poultry, pork and lamb.

7. The shockwave generator system of claim 1 in which the subsystem drives the piston at a velocity in the range of about 50 to 150 m/s.

8. The shockwave generator system of claim 1 in which the piston generates an incident shock pressure on the volume of fluid that has a pressure in the range of about 700 bar to 2000 bar.

9. The shockwave generator system of claim 8 in which the piston generates an incident shock pressure having a pressure of about 1500 bar.

10. The shockwave generator system of claim 1 in which the piston has a mass in the range of about 2 pounds to about 12 pounds.

11. The shockwave generator system of claim 1 in which the driving subsystem includes a source of a pressurized gas delivered to the cylinder to drive the piston to impact the fluid.

12. The shockwave generator system of claim 1 in which the driving subsystem includes an electric linear motor.

13. The shockwave generator system of claim 1 in which the driving subsystem includes a combustion generating device.

14. The shockwave generator system of claim 1 in which the driving subsystem includes springs in communication with the piston.

15. The shockwave generator system of claim 1 in which the driving subsystem includes a hydraulic device.

16. The shockwave generator system of claim 1 in which the piston is concave shaped for generating a complex shockwave.

17. The shockwave generator system of claim 1 in which the piston is convex shaped for generating a complex wave form.

18. The shockwave generator system of claim 1 in which the piston includes an angled head for generating a complex shockwave.

19. The shockwave generator system of claim 1 in which the volume of fluid includes a linear pocket feeder which continuously presents the food product to be processed.

20. The shockwave generator system of claim 19 in which the linear pocket feeder includes a conduit in fluid communication with the cylinder and a plurality of pistons connected by rods travelling in the conduit.

21. The shockwave generator system of claim 20 in which the conduit includes fluid lines for filling a volume of fluid between two adjacent pistons of the plurality of pistons to form a plurality of filling stations to provide the volume of fluid about the food product.

22. The shockwave generator system of claim 21 in which the conduit includes fluid lines for draining the volume of fluid about the food product and between adjacent pistons to form a plurality of draining stations.

23. A non-explosive shockwave generator system for hydrodynamic pressure processing of food products, the generator comprising:
a volume of fluid about a food product;
a piston in a cylinder arranged to strike the volume; and
a subsystem for driving the piston to impact the volume of fluid to create a planar shockwave which travels through the food product.

24. A non-explosive shockwave generator system for hydrodynamic pressure processing of food products, the generator comprising:
a volume of fluid about a food product;
a striking element arranged to strike the volume; and
a subsystem for driving the striking element to impact the volume of fluid to create a shockwave which travels through the food product.

25. A non-explosive shockwave generator system for hydrodynamic pressure processing of food products, the generator comprising:
a volume of fluid about a food product;
a piston in a cylinder arranged to strike the volume;
a subsystem for driving the piston to impact the volume of fluid to create a shockwave which travels through the food product; and
a linear pocket feeder which continuously presents the food product to be processed.

26. The shockwave generator system of claim 25 in which the pocket feeder includes a conduit in fluid communication with the cylinder and a plurality of pistons connected by rods travelling in the conduit.

27. The shockwave generator system of claim 26 in which the conduit includes fluid lines for filling a volume of fluid between two adjacent pistons of the plurality of pistons to form a plurality of filling stations to provide the volume of fluid about the food product.

28. The shockwave generator system of claim 26 in which the conduit includes fluid lines for draining the volume of fluid about the food product and between adjacent pistons to form a plurality of draining stations.

29. A non-explosive method for generating a shockwave for hydrodynamic processing of food products, the method comprising:
delivering a food product to a volume of fluid; and
impacting the volume of fluid to create a shockwave which travels through the food product.

30. The method of claim 29 in which the impacting including driving a piston in a cylinder arranged to strike the volume of fluid.

31. The method of claim 30 in which the volume of fluid includes a portion within the cylinder.

32. The method of claim 30 in which the cylinder includes a volume of gas proximate the volume of fluid.

33. The method of claim 29 in which the food product is chosen from the group consisting of beef, poultry, pork and lamb.

34. The method of claim 30 in which pressurized gas drives the piston to impact the fluid.

35. The method of claim 30 in which an electric linear motor drives the piston.

36. The method of claim 30 in which combustion is used to drive the piston.

37. The method of claim 30 in which at least one spring drives the piston.

38. The method of claim 30 in which the piston is driven hydraulically.

39. A non-explosive method for generating a shockwave for hydrodynamic processing of food products, the method comprising:
delivering a food product to a volume of fluid; and
applying a non-explosive force to the volume of fluid to create a shockwave that travels through the food product.

40. A non-explosive method for generating a shockwave for hydrodynamic processing of food products, the method comprising:
delivering a food product to a volume of fluid; and
tenderizing and destroying microbial organisms in the food product by applying a non-explosive force to the volume of fluid to create a shockwave that travels through the food product.

41. A non-explosive method for generating a shockwave for hydrodynamic processing of food products, the method comprising:
sequentially delivering a food product to a volume of fluid using a linear pocket feeder; and
driving a piston in a cylinder arranged to strike to volume to impact the volume of fluid to create a shockwave which travels through the food product.

42. The method of claim 41 in which the pocket feeder includes a conduit in fluid communication with the cylinder and a plurality of pistons connected by rods travelling in the conduit.

43. A non-explosive method for generating a shockwave for hydrodynamic processing of food products, the method comprising:
sequentially delivering a food product to a volume of fluid using a linear pocket feeder; and
applying a non-explosive force to the volume of fluid to create a shockwave that travels through the food product.
